(19) United States
(12) Patent Application Publication
(10) Pub. No.: US 2009/0169200 A1
(43) Pub. Date: Jul. 2, 2009

(54) METHOD, SYSTEM AND APPARATUS FOR PROTECTING WAVELENGTH DIVISION MULTIPLEX TRANSMISSION

(75) Inventors: Hanguo LI, Shenzhen (CN); Ming CHEN, Shenzhen (CN); Bin HONG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/367,339

(22) Filed: Feb. 6, 2009

Related U.S. Application Data
(63) Continuation of application No. PCT/CN2007/070380, filed on Jul. 30, 2007.

(30) Foreign Application Priority Data
Aug. 9, 2006 (CN) 200610110579.2

(51) Int. Cl. H04J 14/02

(52) U.S. Cl. 398/7; 398/79

(57) ABSTRACT

A method for protecting WDM transmission. On the first transmission direction, the first node implements service transmission to the second node by selecting one from the two transmission paths protected by each other, the second node implements two-path reception based on the two transmission paths; on the second transmission direction contrary to the first transmission direction, the second node implements two-path service sending via the two transmission paths protected by each other, the first node implements reception by selecting one from the two transmission paths. A system for implementing the WDM transmission protection and an apparatus thereof.

### CROSS-REFERENCE TO RELATED APPLICATIONS

This application is a continuation of International Patent Application No. PCT/CN2007/070380, filed Jul. 30, 2007, which claims priority to Chinese Patent Application No. 200610110579.2, filed Aug. 9, 2006, both of which are hereby incorporated by reference in their entirety.

### FIELD OF THE INVENTION

The present invention relates to the transmission of communication field, and in particular, to a method, a system and a device for protecting Wavelength Division Multiplex (WDM) transmission in Metro Access Network.

### BACKGROUND OF THE INVENTION

In the Metro Access Network, Passive Optical Network (PON) is a most popular fiber access approach conventionally. However, with an optical fiber, the highest speed of only 1.25 Gbps or 2.5 Gbps may be supported, while, in practice, the speed of a network card commonly used in a computer of a user is up to 100 Mbps, and the access bandwidth is only 2 Mbps may be provided, which may not satisfy the increasing demands of the customers. As a result, a fiber access with higher bandwidth is required. WDM technologies have already been commercialized for use in large scale in Backbone Network and Metro Area Network (MAN), and its bandwidth may be upgraded and expanded continuously by adding wavelengths with the demands. With the fast increase of the access bandwidth, it has been a trend for WDM technologies to be applied to the access layer. While, conventionally, Point-to-Point transmission is used in WDM technologies, which results in a high cost for applying WDM technologies on the access layer. Therefore, a new technology is needed to reduce the application cost. In the conventional art, a combination of WDM technologies and PON technologies is commonly used, as shown in FIG. 1, there are respectively a plurality of n downstream transmitters and n upstream receivers at a center node, which are respectively used for transmitting an optical wavelength service in the downstream path and for receiving an optical wavelength service in the upstream path. The optical wavelength service in the downstream path first passes through a Wavelength Division Mux/DeMux, and transmits to another Wavelength Division Mux/DeMux at a distribution node via a backbone fiber, and then inputs into a downstream receiver at a terminal node respectively. The same approach is used for the transmission of an optical wavelength service in the upstream path. As can be seen from the description for FIG. 1, different wavelengths may be utilized by terminal nodes in WDM-PON solutions in the conventional art, which provides more bandwidths for use.

When, in practice, a WDM transmission system is used in a real network, because a large amount of customers' data is carried in the WDM transmission system which provides a plurality of wavelengths, and a bandwidth per wavelength for data transmission is in an order of Gbps magnitude, once a fault occurs, services of important customers or many other customers may possibly be impacted seriously, which accordingly causes a big loss to the Carriers. Therefore, the WDM transmission system requires to be protected for providing a higher reliability. In general, in a network, it is in the transmission medium, i.e., an optical fiber, that a fault always occurs. For example, there occurs a case that the optical fiber in the underground fiber cables are cut off during municipal constructions or the construction of a new building, which accordingly causes a fault of network connection occurs. As a result, the Carrier requires a reliable technique for protecting the wavelength services.

The network protection techniques generally used include: dual-transmission-selective-reception path dedicated protection with 1+1, path-shared protection with 1:1 or M:N, and Multiplex Section Protection (MSP), among which the dual-transmission-selective-reception path dedicated protection with 1+1 is a most commonly used scheme. In the dual-transmission-selective-reception path dedicated protection with 1+1 scheme, a working path and a backup path with different routings are used for transmitting the services to be protected, and the backup path is not used for transmitting other services. When fault occurs in transmission lines, it will be detected by the monitoring point corresponding to the service connections, so that the services may be switched from the working path to the backup path automatically depending on the fault type and the protection scheme to ensure the availability of the service.

The structure diagram of the dual-transmission-selective-reception path dedicated protection with 1+1 is shown in FIG. 2 where a permanent bridge connection is used. A downstream and upstream, two-way service signals exist between a transmitting-end node A and a receiving-end node B, both of which have a working path and a backup path. The downstream service signal at node A first passes through a permanent-bridge-connection splitter (such as an optical coupler) which splits the service signal sent from the transmitting-end node A into totally the same two-way signals which respectively are transmitted via the working path and the backup path; and a selector (such as an optical switch) is used at the receiving-end node B for selecting one of the two-way signals. The protection switching of the upstream service signal may be realized in the same way as above stated.

Now an example is provided with a downstream service from the node A to the node B. Because the node B detects the services both in the working path and in the backup path simultaneously, and when a fault occurs in the working path and is detected by the node B, the fault is reported and the selective switch of the node B is controlled to be switched from the working path to the backup path so as to realize the protection of the service. The fault detection and the switching are performed at a same node without informing another node; therefore, the interaction of messages is not required between two nodes via communication protocols. This way is referred as a single-end switch. Similarly, a same mechanism is used for the service from the node B to the node A.

In the conventional art, the single-end switch mode, in which both the detection and switching are made at the receiving end, is used for the 1+1 protection scheme, and a permanent bridge connection is made at the transmitting end. In this mode, a device for switching selection is required at the receiving end. When this scheme is applied in a bi-directional transmission network, a power supply is required at the both end nodes. When the scheme is applied in a Metro Access Network, power must be supplied at the switching node if the downstream path is required to be protected. If only the fiber from the center node to the distribution node in FIG. 1 is to be switched with protection, the distribution node shall works in active mode; therefore, a Passive Optical Network (PON) technique may not be implemented.

In the optical fiber access, the optical fiber is connected from the center node to a number of buildings or residential areas, and then connected to the devices in the machine room of the residential areas or the buildings. In real network constructions, fibers are commonly laid by the side of road or the building in advance; and when there presents a user in the areas and the buildings, the optical fiber is connected with the laid fibers. Because a device requiring a power supply may not be used for the distribution in the middle, a fiber distribution node by the side of road or building is required to be a passive distributor device, while the center node and the terminal node at the ends of the fiber may be supplied with power in the machine room.

Power may be supplied both at the center node and the terminal node, while the distributor node, which is generally placed by the side of road or at a relatively simple environment, has no power supply. If dual-transmission-selective-reception of the downstream service is to be performed, a power supply is required to be provided at this distributor node for implementing switching action of an optical switch or an electrical switch. In order to guarantee the reliability of the equipment, peripheral devices, such as air conditioners are always needed to ensure the environment temperature and moisture under which the equipment and devices run may meet the requirements of the reliability thereof, which accordingly causes a huge cost for the construction of the distributor node.

### SUMMARY OF THE INVENTION

An embodiment of the invention provides a method, a system and a device for protecting WDM transmission, which may actualize a passive distributor node so as to reduce the total cost of network construction.

An embodiment of the invention provides a method for protecting WDM transmission, where in a first transmission direction, a first node transmits a service to a second node via one path selected from the two transmission paths protected mutually, and the second node receives the service in the two transmission paths, i.e., performs a dual reception; in a second transmission direction opposite to the first transmission direction, the second node transmits a service to the first node via two transmission path protected mutually, i.e., performs a dual transmission, and the first node receives the service via one path selected from the two transmission paths.

An embodiment of the invention further provides a system for protecting WDM transmission, which includes a first node and a second node connected with each other via an optical fiber in the WDM system; the first node includes, a selective-transmission module adapted to transmit a service to a second node via one path selected from two transmission paths protected mutually in a first transmission direction, and a selective-reception module adapted to receive a service from the second node via one path selected from two transmission paths protected mutually in a second transmission direction; the second transmission direction is opposite to the first transmission direction; the second node includes, a dual-reception module adapted to receive the service from the first node via the two transmission paths protected mutually, i.e., perform a dual reception, in the first transmission direction; and a dual-transmission module adapted to transmit the service to the first node via the two transmission paths protected mutually, i.e., perform a dual transmission, in the second transmission direction.

An embodiment of the invention further provides a device for protecting WDM transmission, which includes, a dual-reception module adapted to receive a service in two transmission paths protected mutually, i.e., perform a dual reception, in a first transmission direction; and a dual-transmission module adapted to transmit a service via two transmission paths protected mutually, i.e., perform a dual transmission, in a second transmission direction; and the second transmission direction is opposite to the first transmission direction.

An embodiment of the invention further provides a device for protecting WDM transmission, which includes, a selective-transmission module adapted to transmit a service via one path selected from two transmission paths protected mutually in a first transmission direction, and a selective-reception module adapted to receive a service via one path selected from two transmission paths protected mutually in a second transmission direction; and the second transmission direction is opposite to the first transmission direction.

An embodiment of the invention further provides a system for protecting WDM transmission, which includes a center node, a distributor node and a terminal node; the distributor node is connected with the center node via a backbone optical fiber, and the distributor node is connected with the terminal node via a distribution optical fiber; the distributor node includes two or more permanent bridge connector, and at least two of which are respectively used for a dual-reception downstream service and a dual-transmission upstream service.

An embodiment of the invention further provides a method for protecting WDM transmission, including: a terminal node detects whether a fault occurs in a downstream service; if a fault occurring in the downstream service is detected, the terminal node identifies a downstream path in which the fault occurs, and generates downstream path fault information; the terminal node transmits the downstream path fault information to a center node via an upstream path; and the center node switches the downstream service from a working path to a backup path.

It can be seen from the above technical solution in the invention, an asymmetric protection scheme is utilized in opposite transmission directions, in other words, selective transmission and dual reception is performed in a first transmission direction, while dual transmission and selective reception is performed in an opposite second transmission direction. This allows a distributor node without a dedicated power supply or other equipments such as air conditioners, so as to largely reduce the construction cost of a WDM access network with protection function.

### BRIEF DESCRIPTION OF THE DRAWINGS

FIG. 1 is a schematic diagram showing the architecture of a WDM-PON;

FIG. 2 is a schematic diagram showing the architecture of 1+1 protection scheme;

FIG. 3 is a schematic diagram showing a system for protecting a WDM working path provided in a first embodiment of the invention;

FIG. 4 is a flow chart showing self-healing protection with selective-transmission-dual-reception for a downstream service provided in the first embodiment of the invention;

FIG. 5 is a 1+1 protection scheme of sub-network connection provided in a second embodiment of the invention;

FIG. 6 is a schematic diagram showing an architecture of WDM-PON network including a passive distributor node according to an embodiment of the invention; and

FIG. 7 is a schematic diagram showing architecture of a system for protecting WDM transmission according to an embodiment of the invention.

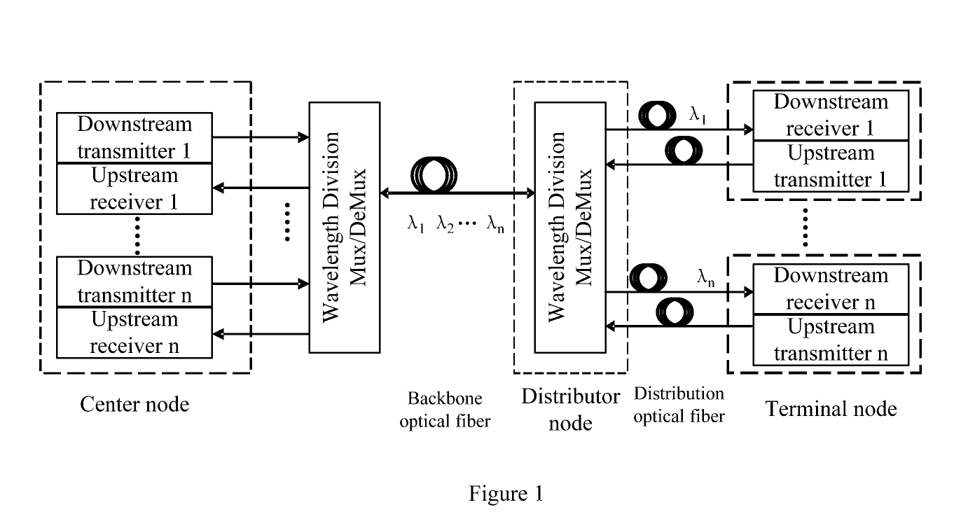

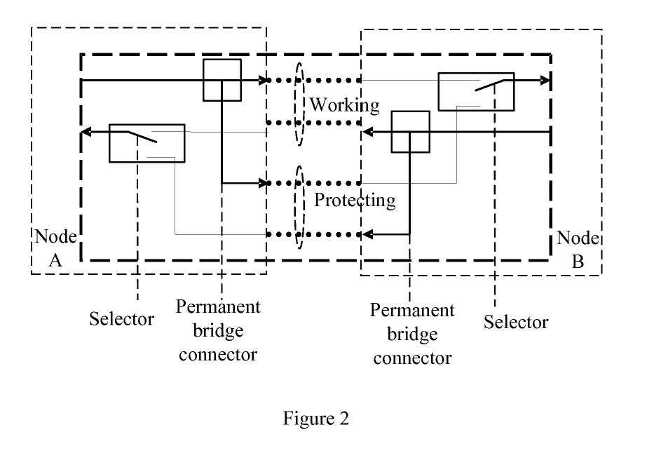

### DETAILED DESCRIPTION OF THE EMBODIMENTS

In an embodiment of the invention, an asymmetrical protection scheme is utilized for a dedicated scenario of an access network. In other words, in a downstream path (i.e., a path in a first transmission direction), such a solution that selective transmission is performed at a transmitting end and dual reception is performed at a receiving end is employed; while in an upstream path (i.e., a path in a second transmission direction opposite to the first transmission direction), such a solution that dual transmission is performed at the transmitting end and selective reception is performed at the receiving end. In this way, a selective mode is used for both the reception and transmission at the side of a center node, while a permanent connection mode is used for a distributor node near the side of users. The distributor node implemented in such a way is not provided with a selective switch, thus may be implemented with a passive device without a power supply, so that peripheral devices such as air conditioners are not required to ensure the working environment temperature and moisture of the devices and equipments to reduce the cost. It is to be appreciated by the skilled in the art, “upstream” and “downstream” is opposite names which represent two transmission directions oppositely. In the embodiments of the invention, “upstream” corresponds to a first transmission direction, and “downstream” corresponds to a second transmission direction opposite to the first transmission direction.

Further descriptions will be made in the invention with reference to the accompanied drawings and embodiments. The permanent bridge connector may include a couple in the embodiments of the invention.

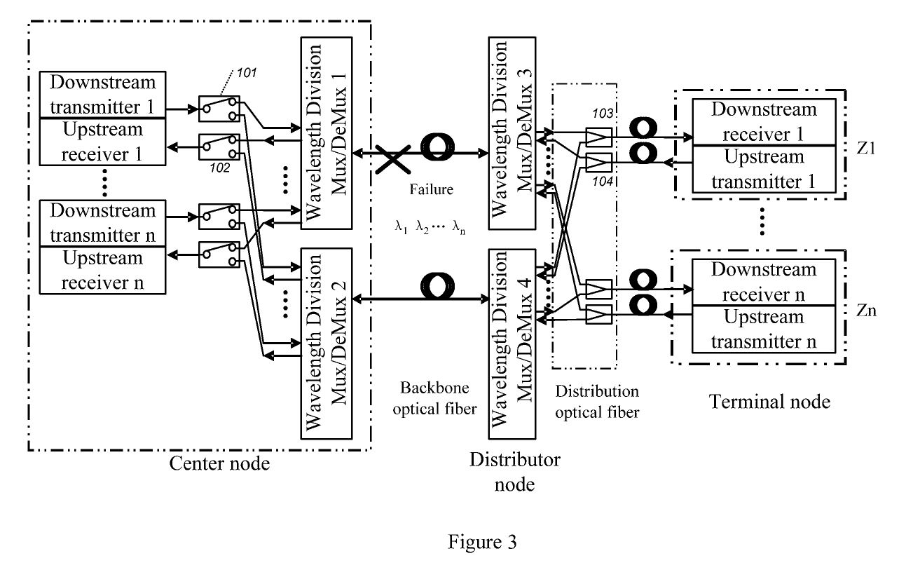

A first embodiment of the invention provides a schematic diagram of a system for protecting a WDM working path, as shown in FIG. 3, Z1, . . . , Zn are a plurality of n terminal nodes.

A center node is provided with a WDM transceiver with a plurality of wavelengths, a downstream transmitter 1 with a certain wavelength and a selective switch module 101 a downstream service is sent thereto. The two outputs of the selective switch module 101 are connected respectively with a Wavelength Division Mux/DeMux 1 and a Wavelength Division Mux/DeMux 2. The Wavelength Division Mux/DeMux 1 is connected with a Wavelength Division Mux/DeMux 3 at a distributor node via a backbone optical fiber as a working path, and the Wavelength Division Mux/DeMux 2 is connected with a Wavelength Division Mux/DeMux 4 at the distributor node via a backbone optical fiber as a backup path. The downstream service passing through the Wavelength Division Mux/DeMux 1 is inputted to an input of a coupler 103 via the Wavelength Division Mux/DeMux 3, and the downstream service passing through the Wavelength Division Mux/DeMux 2 is inputted to another input of the coupler 103 via the Wavelength Division Mux/DeMux 4. Finally, the downstream service is outputted by an aggregate output port of the coupler 103 and inputted to a downstream receiver 1 at a terminal node via a distribution optical fiber.

An upstream service at this wavelength is in an opposite direction to the downstream service. First, an upstream transmitter 1 sends the upstream service to the aggregate input port of a coupler 104. Two same signals are outputted by two output ports of the coupler 104 and then inputted into the Wavelength Division Mux/DeMux 3 and the Wavelength Division Mux/DeMux 4 respectively. The upstream service passing through the Wavelength Division Mux/DeMux 3 is inputted to an input port of a selective switch module 102 via the Wavelength Division Mux/DeMux 1, and the upstream service passing through the Wavelength Division Mux/DeMux 4 is inputted to another input port of the selective switch module 102 via the Wavelength Division Mux/DeMux 2. Finally, the upstream service is outputted by an output port of the selective switch module and inputted to an upstream receiver 1 at the center node via the distribution optical fiber.

Accordingly, the transmission process of upstream and downstream services at other wavelengths is similar as above.

It can be summarized from the above description of the embodiment of the invention that, in a first transmission direction, a first node (e.g., the center node in the above embodiment) transmits a service to a second node (e.g., the distributor node in the above embodiment) via one path selected from two transmission paths protected mutually, and the second node receives the service via both of the two transmission paths. In a second transmission direction opposite to the first transmission direction, the second node transmits a service to the first node via two transmission paths protected mutually, and the first node receives the service via one path selected from the two transmission paths.

In particular, by way of an example in which a first node is a center node and a second node is a distributor node, in a first transmission direction, the center node transmits a service to a distributor node via one path, as a working path carrying the service, selected from two transmission paths protected mutually from the center node to the distributor node. The distributor node receives the service via the two permanently connected transmission paths from the center node to the distributor node. In a second transmission direction (an opposite direction to the first transmission direction), the distributor node transmits a service to the center node via two transmission paths protected mutually between the distributor node and the center node; and the center node transmits the service to customer side via a path selected from the two transmission paths as a working path.

It can be seen that, in the embodiment of the invention, a passive second node may be provided using the asymmetrical protection scheme in the different transmission directions.

The above Wavelength Division Mux/DeMux may be implemented with an Optical Add/Drop Multiplexer (OADM) or a Multiplexer/Demultiplexer (Mux/DeMux) unit; the selective switch module may use an optical switch; and the Wavelength Division Mux/DeMux and the coupler may be implemented in a single node or separate nodes.

As shown in FIG. 3, when fault occurs in the working path from the center node to the distributor node, fault detection is performed at other nodes since the distributor node is passive and unavailable for fault detection, and the center node is informed of the fault for switching. In the technical solution shown in FIG. 3, only the optical fiber from the center node to the distributor node is protected, it is to be appreciated that the integral optical fiber from the center node to the terminal node (i.e., a third node) may be protected to extend the protection scope.

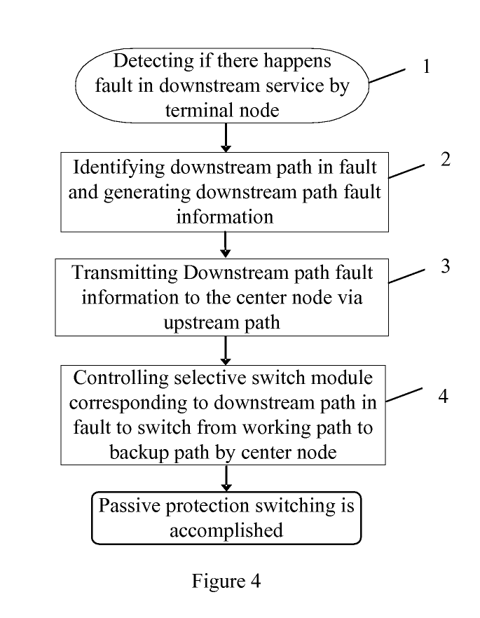

Concerning a downstream service from the center node to the distributor node, because a fault detection unit simply exists at an active node, the downstream service fault may only be detected by the terminal node. A flow chart of an embodiment of showing self-healing protection with selective-transmission-dual-reception for a downstream service is shown in FIG. 4.

In Step 1, the terminal node detects whether there occurs a fault in the downstream service.

A fault detection point may use one of the following approaches for detection: detecting the power of an optical signal split from that to be inputted to the receiving end; detecting whether the service is present or correct using the receiver; or detecting the dedicated overhead of the service to determine whether the service is correct.

In Step 2, the downstream path in fault is identified and downstream path fault information is generated.

In Step 3, the downstream path fault information is transmitted to the center node via an upstream path.

The transmission of the downstream path fault information to the center node may be implemented by using overhead information of the wavelength of the upstream service, or using Out-of-band transmission via an optical monitoring channel, or using a dedicated alarm byte in the upstream service.

In Step 4, the center node controls a selective switch module corresponding to the downstream path in fault to switch from the working path to the backup path.

It can be seen from the Step 1 to 4 above, in this embodiment of detection of the downstream service, the center node performs selective switching for the downstream transmission path based on the upstream path fault information fed by the terminal node via the downstream path.

Concerning an upstream service from the terminal node to the center node via the distributor node, the center node is provided with a fault detection unit and also a selective switch module for protection switching. Upon detection of a fault occurring in the upstream working path, the center node controls the corresponding selective switch module to select a backup path for single-end switching.

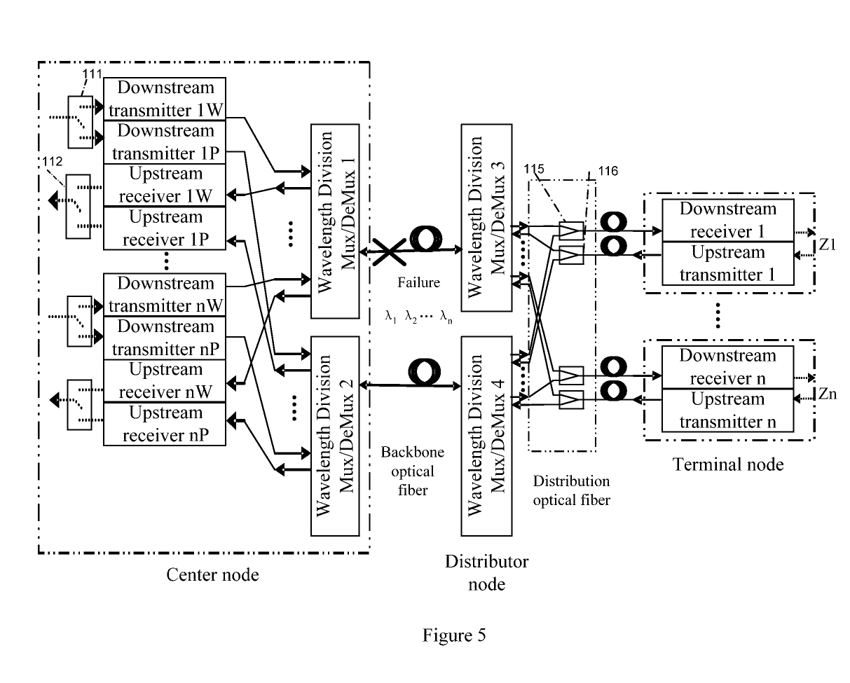

In order to improve further reliability of a WDM transmission system, a second embodiment of the invention is provided with reference to FIG. 5 which shows a structural diagram of a selective-transmission-dual-reception 1+1 protection system of sub-network connection, where Z1, . . . , Zn are a plurality of n terminal nodes, so that the protection switching may be implemented not only when a fault occurs in the working path, but also when a fault occurs in the transmitter or receiver.

The selective switch module here is located between customer signal and a WDM wavelength transceiver. For example, a selective switch module 111 by which a downstream service at a certain wavelength passes may be implemented with an optical switch or an electrical switch. Because the selective switch module 111 is located in front of a transmitter, two transmission modules, i.e., a downstream transmitter 1W and a downstream transmitter 1P, are provided at two outputs of the selective switch module 111 for selective transmission of the downstream service at the certain wavelength. The downstream transmitter 1W and the downstream transmitter 1P are respectively connected with a Wavelength Division Mux/DeMux W and a Wavelength Division Mux/DeMux P. The Wavelength Division Mux/DeMux W is connected with a Wavelength Division Mux/DeMux 3 at a distributor node via a backbone optical fiber as a working path, and the Wavelength Division Mux/DeMux P is connected with a Wavelength Division Mux/DeMux 4 at the distributor node 4 via a backbone optical fiber as a backup path. The downstream service passing through the Wavelength Division Mux/DeMux W is inputted to an input of a coupler 115 via the Wavelength Division Mux/DeMux 3, and the downstream service passing through the Wavelength Division Mux/DeMux P is inputted to another input of the coupler 115 via the Wavelength Division Mux/DeMux 4. Finally, the downstream service is outputted by an aggregate output port of the coupler 115 and inputted to a downstream receiver 1 at a terminal node Z1 via a distribution optical fiber, so as to realize the selective-transmission-dual-reception of the downstream service.

An upstream service at this wavelength is in an opposite direction to the downstream service. First, an upstream transmitter 1 at the terminal node Z1 sends the upstream service to an aggregate input port of a coupler 116; two same signals are outputted by two output ports of the coupler 116 and then inputted into the Wavelength Division Mux/DeMux 3 and the Wavelength Division Mux/DeMux 4 respectively; the upstream service passing through the Wavelength Division Mux/DeMux 3 is inputted to an upstream receiver 1W via the Wavelength Division Mux/DeMux W, and the upstream service passing through the Wavelength Division Mux/DeMux 4 is inputted to an upstream receiver 1P via the Wavelength Division Mux/DeMux P; finally, the upstream service outputted from the upstream receiver 1W and 1P passes through two inputs of a selective switch module 112 respectively, and is outputted from an output port of the selective switch module 112 upon selection, so as to realize the dual-transmission-selective-reception of the upstream service.

Accordingly, the transmission process of upstream and downstream services at other wavelengths is similar as above.

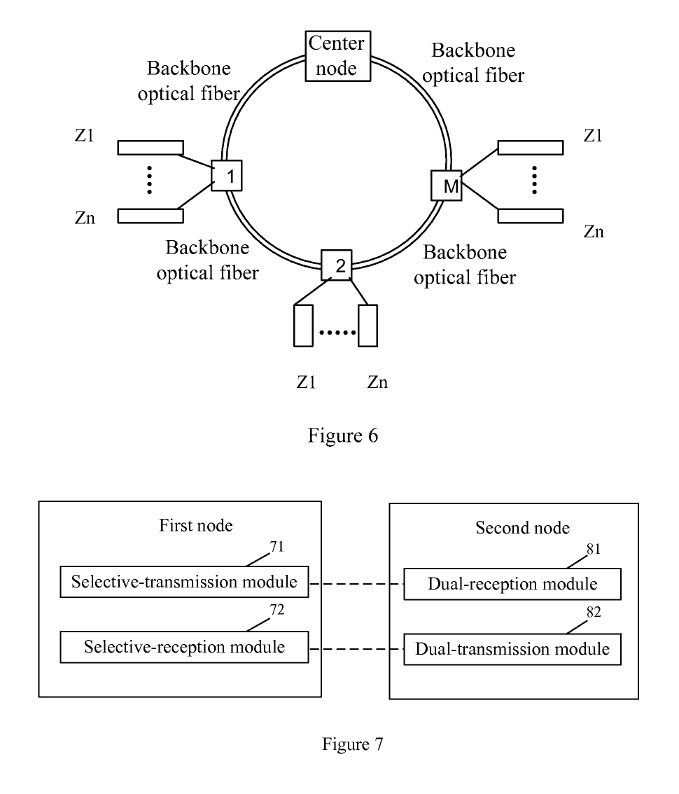

In the first and second embodiments of the invention, only one distributor node is provided. However, in practical use, a plurality of distributor nodes may be provided. In a WMD-PON network architecture including a passive distributor node as shown in FIG. 6, module 1, 2, . . . , M are a plurality of M distributor nodes in the WDM-PON network, each of which corresponds to terminal nodes from Z1 to Zn, and connects with a center node via a backbone optical fiber as a working path and a backup path respectively.

An embodiment of the invention also provides a system for protecting WDM transmission. Please refer to FIG. 7 showing a structural diagram of the system for protecting WDM transmission according to an embodiment of the invention. Here the internal structure and connection relations will be illustrated in detail in conjunction with the working principles of the system.

The system in this embodiment includes a first node and a second node connected with each other via an optical fiber in a WDM system. In particular, the first node includes a selective-transmission module 71 and a selective-reception module 72; and the second node includes a dual-reception module 81 and a dual-transmission module 82.

In a first transmission direction from the first node to the second node, the selective-transmission module 71 at the first node transmits a service to the second node via one path selected from two transmission paths protected mutually, and then the dual-reception module 81 at the second node receives the service sent from the first node via both of the two transmission paths protected mutually, i.e., performs a dual reception.

In a second transmission direction from the second node to the first node (i.e., an direction opposite to the first transmission direction), the dual-transmission module 82 at the second node transmits a service to the first node via two transmission paths protected mutually, i.e., perform a dual transmission, and then the selective-reception module 72 at the first node receives the service sent from the second node via one path selected from the two transmission paths protected mutually.

In particular, the dual-reception module 81 may include a dual-reception permanent bridge connector; the dual-transmission module 82 may include a dual-transmission permanent bridge connector; and the selective-transmission module 71 and the selective-reception module 72 may include a selective switch module.

It can be seen from the structure described above, it is not necessary for the second node to select the transmission path, but keep a permanent connection. Therefore, the second node may not be provided with a power supply device; thus may be passive to reduce the total construction cost of the network. The first node in the above system may be a center node in a WDM system, and the second node may be a distributor node in the WDM system. Vice versa, i.e., the first node in the above system may be a distributor node and the second node may be a center node. It is to be appreciated by the skilled in the art that, when an asymmetrical protection scheme is applied in different transmission directions in a system, one of the nodes may be passive, and it is not intended to limit which one of the nodes may be passive in the embodiments of the invention.

An embodiment of the invention further provides a device for protecting WDM transmission. The node device may be the first node or the second node in the embodiments of the system. The internal structure of the first node and the second node has already been described in the above embodiments of the system; therefore it will not be described here again.

The above description is only for exemplary embodiments and not used to limit the scope of the invention. Various changes and equivalent substitutions without departing from the technical scope of the invention that readily occurred to the skilled in the art shall be covered within the scope of the invention defined by the appended Claims.

What is claimed is:

1. A method for protecting Wavelength Division Multiplex, WDM, transmission, comprising,
transmitting, by a first node, a service to a second node via one path selected from two transmission paths protected mutually in a first transmission direction; and receiving, by the second node, the service via the two transmission paths in the first transmission direction; and
transmitting, by the second node, a service to the first node via two transmission path protected mutually in a second transmission direction opposite to the first transmission direction; and receiving, by the first node, the service via one path selected from the two transmission paths in the second transmission direction.

2. The method according to claim 1, wherein the first node is a center node in a WDM transmission system; and the second node is a distributor node in the WDM transmission system.

3. The method according to claim 2, wherein the transmission process in the first transmission direction comprises,
transmitting, by the center node, a service to the distributor node via one path, as a working path carrying the service, selected from the two transmission paths protected mutually from the center node to the distributor node; and
receiving, by the distributor node, the service carried in the two permanently connected transmission paths from the center node to the distributor node.

4. The method according to claim 2, wherein the transmission process in the second transmission direction comprises,
transmitting, by the distributor node, a service to the center node via the two transmission paths protected mutually between the distributor node and the center node respectively; and
transmitting, by the center node, the service to customer side via a path selected from the two transmission paths as a working path.

5. The method according to claim 4, further comprising,
in the first transmission direction, transmitting, by the second node, the service to a third node upon reception of the service from the first node; and
in the second transmission direction, receiving, by the second node, the service from the third node before transmitting a service to the first node via two transmission path protected mutually by the second node.

6. The method according to claim 2, further comprising,
performing, by the first node, selective switching for the transmission path in the first transmission direction based on path fault information in the first transmission direction fed back by the third node via the path in the second transmission direction.

7. The method according to claim 6, wherein the process for performing selective switching for the transmission path in the first transmission direction by the first node comprises,
detecting, by the third node, if there occurs a fault in the service in the first transmission direction;
transmitting, by the third node, path fault information in the first transmission direction to the first node via the path in the second transmission direction, upon detection of a fault occurring in the service in the first transmission direction; and
switching, by the first node, the service in the first transmission path from the working path to a backup path between the two transmission paths protected mutually.

8. The method according to claim 5, wherein the third node is a terminal node.

9. The method according to claim 4, further comprising,
detecting, by the first node, if there occurs a fault in the service in the second transmission direction; and
performing, by the first node, selective switching for the receiving path in the second transmission path, upon detection of a fault occurring in the service in the second transmission direction.

10. A system for protecting Wavelength Division Multiplex, WDM, transmission, comprising a first node and a second node connected with each other via an optical fiber in the WDM system, wherein,
the first node comprises,
a selective-transmission module adapted to transmit a service to a second node via one path selected from two transmission paths protected mutually in a first transmission direction, and
a selective-reception module adapted to receive a service from the second node via one path selected from two transmission paths protected mutually in a second transmission direction; wherein the second transmission direction is opposite to the first transmission direction;
the second node comprises,
a dual-reception module adapted to receive the service from the first node via the two transmission paths protected mutually in the first transmission direction; and
a dual-transmission module adapted to transmit the service to the first node via the two transmission paths protected mutually in the second transmission direction.

11. The system according to claim 10, wherein the first node is a center node and the second node is a distributor node.

12. A device for protecting Wavelength Division Multiplex, WDM, transmission, comprising,
a dual-reception module adapted to receive a service via two transmission paths protected mutually in a first transmission direction; and
a dual-transmission module adapted to transmit a service via two transmission paths protected mutually in a second transmission direction; wherein the second transmission direction is opposite to the first transmission direction.

13. The device according to claim 12, wherein the dual-reception module is a dual-reception permanent bridge connector; and the dual-transmission module is a dual-transmission permanent bridge connector.

14. The device according to claim 13, wherein the device is a distributor node in a WDM system.

15. A device for protecting Wavelength Division Multiplex, WDM, transmission, comprising,
a selective-transmission module adapted to transmit a service via one path selected from two transmission paths protected mutually in a first transmission direction; and
a selective-reception module adapted to receive a service via one path selected from two transmission paths protected mutually in a second transmission direction; wherein the second transmission direction is opposite to the first transmission direction.

16. The device according to claim 15, wherein the selective-transmission module and the selective-reception module each are a selective switch module.

17. The device according to claim 16, wherein the device is a center node in a WDM system.

18. A system for protecting Wavelength Division Multiplex, WDM, transmission, comprising a center node, a distributor node and a terminal node; wherein the distributor node is connected with the center node via a backbone optical fiber, and the distributor node is connected with the terminal node via a distribution optical fiber; wherein,
the distributor node comprises two or more permanent bridge connectors, and at least two of which are respectively used for a dual-reception downstream service and a dual-transmission upstream service.

19. The system according to claim 18, wherein the permanent bridge connector is a coupler.

20. The system according to claim 18, wherein,
the center node comprises a downstream transmitter, an upstream receiver, a first selective switch module, a second selective switch module, a first Wavelength Division Multiplexer/De-Multiplexer and a second Wavelength Division Multiplexer/De-Multiplexer;
an input of the first selective switch module is connected with the downstream transmitter, and two outputs of the first selective switch module are connected with the first Wavelength Division Multiplexer/De-Multiplexer and the second Wavelength Division Multiplexer/De-Multiplexer respectively; two inputs of the second selective switch module are respectively connected with the first Wavelength Division Multiplexer/De-Multiplexer and the second Wavelength Division Multiplexer/De-Multiplexer, and an output of the second selective switch module is connected with the upstream receiver.

21. The system according to claim 20, wherein the first selective switch module and the second selective switch module each are an optical switch or an electrical switch.

22. The system according to claim 21, wherein the terminal node comprises a downstream service receiver and an upstream service transmitter; dual-transmission permanent bridge connector of the distributor node.

23. A method for protecting Wavelength Division Multiplex, WDM, transmission, comprising,
detecting, by a terminal node whether a fault occurs in a downstream service;
identifying, by the terminal node, a downstream path in which the fault occurs and generating downstream path fault information, when the fault occurring in the downstream service is detected;
transmitting, the downstream path fault information to a center node via an upstream path; and
switching, by the center node, the downstream service from a working path to a backup path.

24. The method according to claim 23, wherein the detecting whether a fault occurs in the downstream service by the terminal node comprises, detecting, by the terminal node, the power of part of the downstream service signal split from that to be inputted to the receiving end, or detecting the fault directly using a receiver, or detecting overhead of the downstream service for detecting the fault.

25. The method according to claim 24, wherein,
the downstream path fault information is transmitted to the center node via overhead information of an upstream service wavelength; or
the downstream path fault information is transmitted to the center node via an optical monitoring channel; or
the downstream path fault information is transmitted to the center node via an alarm byte in the upstream service.
